(19) United States
(12) Patent Application Publication
(10) Pub. No.: US 2012/0091390 A1
(43) Pub. Date: Apr. 19, 2012

(54) Refrigerant composition on the basis of at least one non-halogenated inflammable hydrocarbon

(75) Inventor: Kristofer BRAUN, Bad Mergentheim (DE)

(73) Assignee: Lauda Dr. R. Wobser GmbH & Co.KG, Lauda-Konigshofen (DE)

(21) Appl. No.: 13/272,488

(22) Filed: Oct. 13, 2011

(30) Foreign Application Priority Data
Oct. 13, 2010 (DE) 20 2010 014 196.6

(51) Int. Cl. C09K 5/04

(52) U.S. Cl. 252/67

(57) ABSTRACT

Refrigerant composition on the basis of at least one non-halogenated inflammable hydrocarbon, in which an addition of at least one refrigerant/extinguishing agent selected from the group of fluorinated hydrocarbons is made.

### BACKGROUND OF THE INVENTION

1. Field of the Invention

The present invention relates to a refrigerant composition on the basis of at least one non-halogenated inflammable hydrocarbon.

2. Description of the Related Art

Hydrocarbons of this sort are referred to a natural hydrocarbons although halogenated hydrocarbons are found in nature as well.

Refrigerants may be defined as working medium which absorbs heat in a refrigerating machine process at low temperature and low pressure and releases heat at an increased temperature and higher pressure (DIN 8960). Typically, the refrigerating machine process takes place in a closed cycle in which a compressor is arranged and can for instance be performed in a cooling thermostat.

The refrigerants may be subdivided into two groups, viz. a group of easily inflammable or combustible refrigerant in the form of naturally existing hydrocarbons such as propane or isobutane, and a group of difficultly or non-inflammable refrigerants including fluorinated hydrocarbons such as pentafluorethane or heptafluorpropane.

It has also been known to employ specific fluorinated hydrocarbons, such as pentafluor-ethane, commercial name “Solkaflam®125”, or heptafluorpropane, commercial name “Solkaflam®227”, as chemical extinguishing agent which serve to extinguish burning material.

Naturally found inflammable refrigerants are particularly economical; by the refrigerant users, however, they are poorly accepted though with a view to the risks connected with the natural flammability thereof. The non-inflammable refrigerants, on the other hand, such as for example pentafluorethane as a so-called greenhouse gas, may be subject to restrictions with a view to the environmental load, and they are more expensive.

### BRIEF SUMMARY OF THE INVENTION

It is the aim of the present invention to provide a refrigerant wherein the refrigeration properties of which should, as far as possible, not be worse than those of naturally found hydrocarbons which, however, is difficultly inflammable, causes only little damage to the environment, yet can economically be produced.

The above object is accomplished by the present invention in which the refrigerant composition consists substantially, i.e. predominantly, of a non-halogenated inflammable hydrocarbon and an addition of a refrigerant/extinguishing agent selected from the group consisting of the fluorinated hydrocarbons.

### DETAILED DESCRIPTION OF THE INVENTION

In the present invention, a refrigerant composition consists substantially, i.e. predominantly, of a non-halogenated inflammable hydrocarbon and an addition of a refrigerant/extinguishing agent selected from the group consisting of the fluorinated hydrocarbons.

Using such a suitable addition which is not only used as a refrigerant itself but, in addition, shows also fire inhibiting properties, a difficultly inflammable refrigerant composition having excellent cryogenic properties while nor harmful to the environment is obtained which in view of its high proportion of the fluorinated hydrocarbon can economically be produced. The addition of the fluorinated hydrocarbon acts chemically fire inhibiting on the complete composition.

In the present invention, the refrigerant/extinguishing agent pentafluorethane C₂HF₅, R125 according to DIN, is selected as the fire exhibiting additive, or heptafluorpropane C₃HF₇, R227 according to DIN. (Remark: DIN—Deutsche Industrie Norm—German Industrial Standards.)

A composition of at least 90 mass percentage of propane R290 according to DIN with an addition of a maximum of 10 mass percentage of pentafluorethane is particularly suitable. In connection with low-temperature technology, it is favourable in this case that pentafluorethane and the natural inflammable refrigerant propane show similar pressure/temperature ratios. A further favourable composition having similar pressure/temperature ratios of the composition constituents consists of at least 90 mass percentage of isobutane, R600a according to DIN, and an addition of a maximum of 10 mass percentage of heptafluorpropane.

In both cases, an effective reduction of the fire risk is obtained by a small addition of pentafluorethane, or heptafluorpropane, as the fire inhibiting additive considering the substantially reduced flammability of the composition included in this additive.

1. A refrigerant composition on a basis of at least one non-halogenated inflammable hydrocarbon, further comprising at least one refrigerant/extinguishing agent selected from the group consisting of fluorinated hydrocarbons.

2. The refrigerant composition according to claim 1, wherein said fluorinated hydrocarbons comprises pentafluorethane.

3. The refrigerant composition according to claim 1, wherein said fluorinated hydrocarbons comprises heptafluorpropane.

4. The refrigerant composition according to claim 2, wherein said inflammable hydrocarbon comprises propane, and said composition comprises at least 90 mass percentage of said propane and a maximum of 10 mass percentage of said pentafluorethane.

5. The refrigerant composition according to claim 3, wherein said inflammable hydrocarbon comprises isobutane, and said composition comprises at least 90 mass percentage of said isobutane and a maximum of 10 mass percentage of said heptafluorpropane.
